(19) United States
(12) Patent Application Publication
(10) Pub. No.: US 2012/0240226 A1
(43) Pub. Date: Sep. 20, 2012

(54) NETWORK ROUTERS AND NETWORK TRAFFIC ROUTING METHODS

(76) Inventor: Weichen Li, Beijing (CN)

(21) Appl. No.: 13/421,631

(22) Filed: Mar. 15, 2012

(30) Foreign Application Priority Data
Mar. 15, 2011 (CN) 201110062043.9

(51) Int. Cl. G06F 21/00; G06F 15/173

(52) U.S. Cl. 726/22; 709/238; 709/224

(57) ABSTRACT

A network router comprising a first communication interface for receiving traffic from a first traffic source and a second communication interface for receiving traffic from a second traffic source, a processor and memory. The processor of the router is to execute instructions stored in the memory to forward data traffic received at the first communication interface according to a first routing policy and to forward data traffic received at the second communication interface according to a second routing policy.

### BACKGROUND

With the exponential growth of the Internet, the volume of internet data traffic which flow through the Internet and enterprise networks has also grown tremendously, especially when more and more applications are available on-line. At the same time, the complexity of the data being carries has also increased substantially. All these factors have built up pressure on enterprise networks and affected system performance due to the need to identify and filter off illegal data to mitigate the risk of malicious system or data attack. Illegal data can be data which are deliberately transmitted for malicious attack or can be data which become illegal due to corruption during transmission or other errors. To determine whether certain data are legal or illegal, the processor of a security detection device will operate to check the behaviour of the target against a given safety specification and decide whether to remove the target or to permit through passage.

In order to relieve the processing burden on servers or dedicated networks, devices commonly known as external security monitors (ESMs) are often used to process risky incoming data traffic alongside a server or dedicated network. Well-known ESMs include firewall, IDS, IPS, DDoS traffic cleaning system, content checking device. ESMS are also known as external hanging detection systems since they are usually connected to a server or a dedicated network by means of a side-hanging topology.

In an example network, a router is disposed between an external IP network and an internal network comprising an enterprise LAN and a server. An ESM is side-connected to a router using the side-hanging topology. In operation, data coming in from an external IP network on encountering the router will be diverted to an ESM for examination and processing. Targets which survive the examination and processing will be returned to the router for forwarding while targets which are classified as illegal will be removed. When the ESM is faulty or non-operational, traffic will bypass the ESM, flow through the router, and then enter the internal network. Typically, traffic diversion is handled by the BGP (Border Gateway Protocol) and reinjection into the router is by means of policy-based routing.

### BRIEF DESCRIPTION OF FIGURES

Example implementations of routers and routing methods according to the present disclosure will be described below with reference to the accompanying drawings, in which:—

FIG. 1 is a schematic diagram depicting an example router according to the present disclosure,

FIG. 2 is a schematic diagram depicting an example network comprising a router of FIG. 1 in cooperation with a side-hanging security detection device,

FIG. 3 is a schematic diagram depicting a side-hanging detection system comprising another example router of the present disclosure disposed in a multiple-router environment, and

FIG. 4 is a diagram illustrating an example of traffic flow under the control of a router according to the disclosure.

### DETAILED DESCRIPTION

A router 100 depicted schematically in FIG. 1 comprises a first communication interface 110, a second communication interface 120, a processor 130 and memory 140. The router 100 is a standalone router having a rigid housing. As an alternative, the router can be a plug-in router module. The memory may be a single memory device comprising a first memory area allocated to store instructions for execution by the processor to operate the router, and a second memory area allocated to store the contents of a routing table. Alternatively, the memory 140 may comprise several discrete memories such as memory modules. For example, the memory for storing processor instructions may be an EEPROM, RAM etc, while the memory for the routing table may be a dedicated memory such as a TCAM. The router table is divided into two parts. The first part is for defining the routing policy for data traffic coming in at the first communication interface. The second part is for defining the routing policy for data traffic coming in at the second communication interface. The memories can be RAM or other read-writable memories and division of memories to define different parts of the routing table can be logical or physical without loss of generality. Contents of first part of the routing table are set and modified by the processor, and can be subsequently re-set, modified, or updated according to routing policy information or instructions provided by the security detection device. Intervals for content updating can be periodical or can be determined by events such as detection of new virus or new malicious traffic source.

The first communication interface 110 is for making traffic connection between the router and an external traffic source such as an Internet source or an external network. A switchable data link is connected to the first communication interface so that data traffic arriving at the first communication interface can be forwarded to the security detection device or to the next intended destination connected to the router under the control or switching of the processor. The switching of the data link to a selected outgoing path is controlled by the processor which determines the outgoing path switching according to a routing policy set in the first part of the routing table.

The second communication interface is for making traffic connection with a security detection device. The security detection device can be an external or a stand-alone ESM device connectible to the router, or a module which can be built in to the router. The security detection device is provided to examine and detect incoming traffic according to a given safety specification such that illegal traffic according to the safety specification will be removed or blocked and legal traffic will be returned to the router for forwarding to the destination. A data link is connected to the second communication interface to facilitate onward transmission of data traffic to the next schedule destination.

To set or modify the first part of the routing table, the security detection device will send a BGP routing to the router. The processor of the router upon receipt of the BGP routing information will set or modify the first part of the routing table.

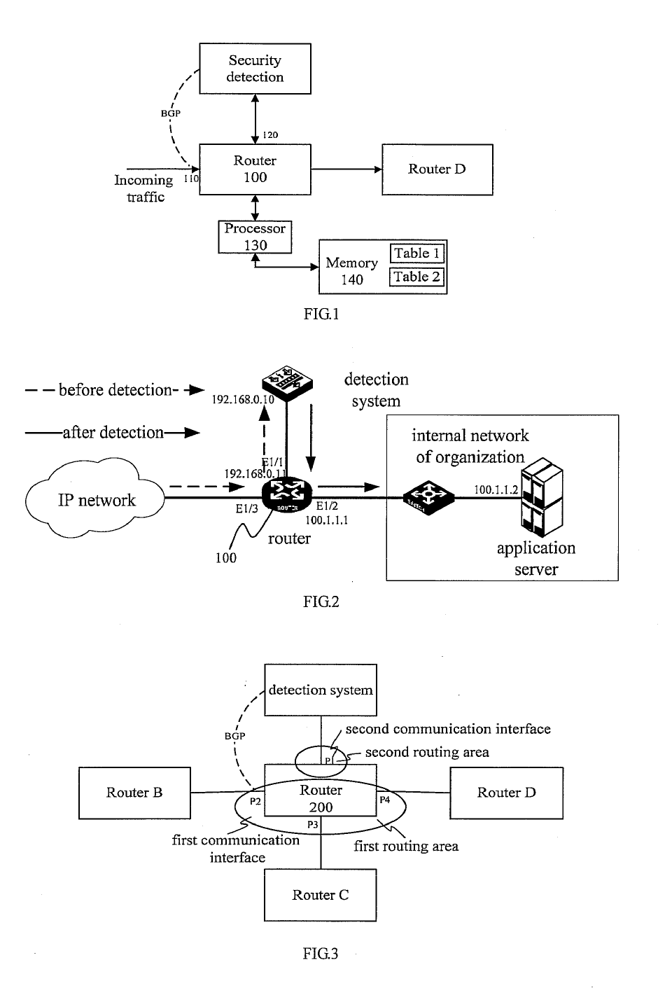

In an example application as shown in FIG. 2, the router 100 is disposed intermediate an example external traffic source of an IP network and an example next destination of an internal network. The router operates as a first security gatekeeper in this network configuration.

During operation, the router processor will process incoming traffic coming form the external IP network and arriving at the first communication interface according to the routing policy set in the first part of the routing table. The processor of the router will determine according to the routing policy defined in the first part of the routing table whether to forward to the security detection device or to forward to the next destination without going through the security detection device. When the data traffic is diverted to the security detection device according to the routing policy of the first routing table, the selected data traffic will be examined with reference to a safety specification. Data traffic which passes the security examination will be returned to the router at the second communication interface for onward transmission to the next scheduled destination according to the routing policy already set in the second part of the routing table. Return of the examined data traffic back to the router is referred to as ‘injection’ to persons skilled in the art. The processor will update the routing policy of the first part of the routing table from time to time according to the BGP routing information supplied by the security detection device.

An example operation of the router will be described with reference to the flow chart of FIG. 4. At 202, the processor will divide the second memory area into a first region for storing a first routing table for use in connection with traffic coming into the first communication interface which is adapted for external communication, and a second region for storing a second routing table for use in connection with traffic coming into the second communication interface which is adapted for receiving data traffic from the security detection system. When data traffic is received at the first communication interface at 203, the processor will look up at the first routing table and determine the onward transmission path. When the processor receiving new routing information from the security detection system at 204, the processor will modify and update the routing policy and contents of the first routing table.

In another example, sub networks such as 100.1.1.0/24 and 100.1.1.12/32 are accessible through router 100, and operation of the router is changed from a pass-through router to a router in cooperation with the security detection device to be described with reference to the network of FIG. 2, in which:—
IP address of the internal application server is: 100.1.1.2;
IP address of the security detection device is: 192.168.0.10;
IP address of the router interface in connection with the security detection device is: 192.168.0.11;
IP address of the router interface in connection with the internal network is: 100.1.1.1.

In this router, a first routing table is used to route traffic incoming through the router interface E1/1, while a second routing table is used for traffic incoming through other interfaces, namely E1/2 and E1/3. For security reasons, the second routing table is changed so that traffic incoming through interface E1/3 which is connected to the internet and having certain destination IP address can be sent to the detection system.

When there is no need to use the security detection device to examine data traffic for illegal traffic, the policy of the first and second routing tables are the same as follows:

| Sub Network | NextHop | Interface |
|---|---|---|
| 100.1.1.0/24 | 100.1.1.1 | E1/2 |
| . . . | | |

On the other hand, when it is desirable to activate traffic examination to block illegal traffic, the security detection device will send updated BGP routing to the router, and when this happens, the router processor will keep the policy set in the first routing table provided for interface E1/1 unchanged as above and update the policy set in the second routing table provided for interfaces E1/2 and E1/3 as follows:

| Sub Network | NextHop | Interface |
|---|---|---|
| 100.1.1.2/32 | 192.168.0.10 | E1/1 |
| 100.1.1.0/24 | 100.1.1.1 | E1/2 |

With the addition of the new routing policy, traffic having a destination IP address of 100.1.1.2 and incoming through the interface E1/3 will be forwarded according to this routing to the security detection device. After passing the security examination, the traffic will be returned to the router 100 at the communication interface E1/1. According to the policy set in the first routing table, the data traffic with destination. IP address of 100.1.1.2 will be forwarded to the internal network through interface E1/2, and finally to the internal application server.

In this disclosure the term “communication interface” is used to refer to a “number” of communication ports that correspond to a given routing area and routing table, wherein said “number” one or greater. Thus, whereas in the above example “communication interface” corresponds to a single communication port, in other examples a “communication interface” may correspond to several communication ports.

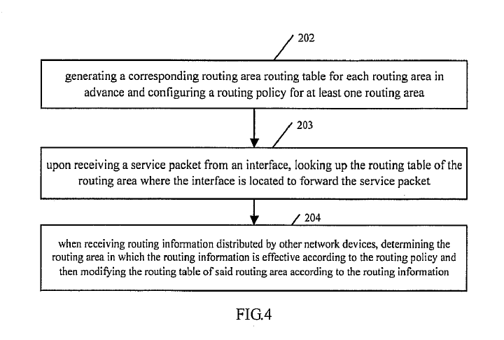

Another example router depicted in FIG. 3 is deployed in a multi-router network configuration. The router 200 is identical to that of FIG. 1 except that the first communication interface comprises three communication ports for making data traffic connection separately with three adjacent routers B, C, D. In this router, the routing table also comprises a first part and a second part. The first part of the routing table is for defining the routing policy for data traffic coming in at the first routing area which includes the three communication ports P2, P3, P4 of the first communication interface. The second part of the routing table is for defining the routing policy for data traffic coming into the second routing area which includes the single communication port P1 of the second communication interface. The routing policy in the first part of the routing table can be set, modified and updated by the processor according to the BGP routing information provided by the security detection device. In some cases, the first part routing table can be further divided into three logical or physical sub-parts so that a sub-routing table is provided for each individual communication port.

While each example router is connected to a security detection device in the above network examples, it will be appreciated it is not necessary that the router is so connected. For example, data traffic arriving at the first communication interface may be diverted to different destinations which can be another router, server or another network according to the routing policy set out in the first routing table without loss of generality. Likewise, the second communication interface of the router can also be connected to another router, server or another network according to the routing policy set out in the first routing table without loss of generality.

Furthermore, while the examples above have been described with reference to the BGP, it should be appreciated that BPG has been used solely for convenience since it is one of the most popular protocol for traffic security. Furthermore, while the second communication interface of the example routers have been described with reference to one and three connection ports, it should be appreciated that the description does not suggest any limitation on the number of ports which can be determined from time to time with loss of generality.

1. A network traffic routing method for use by a router, the router comprising a first communication interface for receiving traffic from a first traffic source and a second communication interface for receiving traffic from a second traffic source; wherein the method comprises the router:
forwarding data traffic received at the first communication interface according to a first routing policy; and
forwarding data traffic received at the second communication interface according to a second routing policy.

2. A method according to claim 1, wherein the first routing policy is stored in a first routing table and the second routing policy is stored in a second routing table.

3. A method according to claim 1, wherein the method comprises the router receiving routing information to set, modify or update at least one of the first routing policy or the second routing policy.

4. A method according to claim 3, wherein the information to set, modify or update is by way of BGP.

5. A method according to claim 1, wherein the first communication interface of the router comprises a plurality of communication ports, and the method comprising the first routing policy storing routing policies for forwarding incoming traffic received at each one of the plurality of communication ports.

6. A method according to claim 1, wherein the first communication interface is for receiving traffic from an external traffic source and a second communication interface is for receiving traffic from a traffic detection device, the traffic detection device being for detecting illegal or unauthorized traffic; wherein the method comprises forwarding data traffic received at the first communication interface either to an external destination or to the traffic detection device according to the first routing policy.

7. A method according to claim 6, wherein the method comprises forwarding data traffic received at the second communication interface to an external destination.

8. A method according to claim 6, wherein the method comprises the router receiving information from the traffic detection device to set modify or update the first routing policy.

9. A method according to claim 8, wherein the method comprises the traffic detection device sending routing information to the router to set or modify the first routing policy such that data traffic will not be forwarded to the traffic detection device.

10. A method of traffic routing control in a side hanging detection system, the side hanging detection system comprising a router and a security detection device, wherein the router comprises a first communication interface for receiving traffic from an external traffic source and a second communication interface for receiving traffic from a traffic detection device, and the traffic detection device is for detecting illegal or unauthorized data traffic; wherein the method comprises:
the router forwarding data traffic received at the first communication interface either to an external destination or to the traffic detection device according to a first routing table;
the security detection system returning data traffic received from the router to the router at the second communication interface; and
the router forwarding data traffic received at the second communication interface to an external destination according to a second routing table.

11. A network router comprising a first communication interface for receiving traffic from a first traffic source and a second communication interface for receiving traffic from a second traffic source, a processor and memory; wherein the processor is to execute instructions stored in the memory to:
forward data traffic received at the first communication interface according to a first routing policy; and
forward data traffic received at the second communication interface according to a second routing policy.

12. A network router according to claim 11, wherein the first routing policy is stored in a first routing table and the second routing policy is stored in a second routing table.

13. A network router according to claim 11, wherein the processor is to dynamically set modify or update at least one of the first routing policy or the second routing policy according to received routing instructions.

14. A network router according to claim 11, wherein the first communication interface comprises a plurality of data communication ports.

15. A network router according to claim 11, wherein the processor is to forward data traffic received at the first communication interface either to an external destination or to the traffic detection device according to the first routing policy.

16. A network router according to claim 15, wherein the processor is to set to receive instructions to set, update or modify the first routing table from a security detection device.

17. A network router according to claim 15, wherein the processor is to execute instructions stored in the memory to set, update or modify the first routing table according to received routing instructions in BGP.

18. A network router according to claim 15, wherein the processor is to execute instructions stored in the memory to set, update or modify the first routing table to bypass the security detection device.

19. A network router according to claim 15, wherein the first communication interface comprises a plurality of communication ports for connection with a plurality of external traffic sources.
